(19) United States
(12) Patent Application Publication
(10) Pub. No.: US 2026/0276506 A1
(43) Pub. Date: Sep. 17, 2026

(54) MOISTURE METER

(71) Applicant: A&D Company, Limited, Tokyo (JP)

(72) Inventors: Shunsuke KASAMATSU, Kitamoto-shi (JP); Ryota SAITO, Kitamoto-shi (JP); Kazuma FUNAHASHI, Kitamoto-shi (JP)

(73) Assignee: A&D Company, Limited, Tokyo (JP)

(21) Appl. No.: 19/563,595

(22) Filed: Mar. 11, 2026

(30) Foreign Application Priority Data
Mar. 13, 2025 (JP) 2025-040004

(51) Int. Cl. G01N 5/04

(52) U.S. Cl. CPC G01N 5/045

(57) ABSTRACT

A moisture meter includes a moisture meter body 2 including a housing 20 and a mass detection unit accommodated therein that detects a load, a pan receiver 25 attached to the mass detection unit on an upper surface of the housing 20, a sample pan 26 removably placed onto the pan receiver 25, a cylindrical windshield wall 29b provided around the sample pan, and a cover portion 4 that is openably/closably provided on the housing, has accommodates a heating light source therein, covers the sample pan 26 in a closed state, and defines a heating chamber. The windshield wall 29b has a surface thermal reflectance of less than 50%.

### TECHNICAL FIELD

The present disclosure relates to moisture meters and, more particularly, to a heat-drying moisture meter.

### BACKGROUND ART

Heat-drying moisture meters have been known as devices for measuring the moisture of a sample. Patent Literature 1 discloses a heat-drying moisture meter including a mass detection unit accommodated in a box-shaped housing. The mass detection unit is provided with a pan receiver attached to an upper end of a connecting shaft thereof. The pan receiver supports a sample pan, and the sample pan is surrounded by a windshield. The moisture meter has an openable/closable cover member that covers the sample pan from above, which is disposed on an upper portion of the housing. The cover member has a heating light source disposed therein, and a sample pan cover that covers the sample pan between the heating light source and the sample pan. Components constituting the weighing unit of the moisture meter such as the sample pan, the windshield, and the pan receiver are generally made of stainless steel having glossiness from the viewpoint of durability, chemical resistance, and appearance. Glossy stainless steel generally has a high thermal reflectance of 60% or more.

### CITATION LIST

### Patent Literature

Patent Literature 1 JP 2002/303571 A1

Patent Literature 2 JP 9/257680 A1

### SUMMARY

### Technical Problem

Conventional heat-drying moisture meters have problems that convection of air acting on a sample pan, which occurs when a sample is heated, may lower the accuracy of mass detection and lower the accuracy of moisture content measurement. Patent Literature 2 discloses a moisture meter comprising an infrared lamp, an outer cylinder surrounding the lamp, and a skirt surrounding a lower portion of the lamp. The moisture meter is configured such that an upper end of the skirt portion enters the outer with a gap from the inner wall of the outer cylinder, thereby minimizing the influence of convection on a sample pan.

Similarly to Patent Literature 1, the moisture meter including the sample pan cover that covers the sample pan is also required to reduce influence of convection on the sample pan.

As a result of extensive research, the inventors have found that a moisture meter similar to Patent Literature 1 can reduce the influence of convection on a sample pan by decreasing the thermal reflectance of a component constituting a weighing unit.

The present disclosure has been made in view of such circumstances, and an object thereof is to provide a technique for reducing the influence of convection on a sample pan in a heat-drying moisture meter provided with a sample pan cover between a heating light source and the sample pan.

### Solution to Problem

To achieve the above object, a moisture meter according to one aspect of the present disclosure has the following configuration.
1. A moisture meter includes: a moisture meter body including a housing and a mass detection unit accommodated therein that detects a load; a pan receiver attached to the mass detection unit on an upper surface of the housing; a sample pan detachably placed on the pan receiver; a cylindrical windshield wall provided around the sample pan; and a cover portion that is openably/closably provided on the housing, accommodates a heater therein, covers the sample pan in a closed state, to define a heating chamber, wherein the windshield wall has a surface thermal reflectance of 50% or less.
2. In the aspect 1, it is preferable that speed of convection caused by air flowing between an outer edge of the sample pan and the windshield wall and flowing upward along the outer edge of the sample pan is reduced by setting the surface thermal reflectance to 50% or less,
3. In the aspects 1 and 2, it is preferable that a distance between an outer edge of the sample pan and the windshield wall is set in consideration of a speed of convection caused by air flowing between the outer edge of the sample pan and the windshield wall and flowing upward along the outer edge of the sample pan.
4. In the aspects 1 to 3, it is preferable that a distance between an outer edge of the sample pan and the windshield wall is 9 mm or less.
5. In the aspects 1 to 4, it is preferable that wherein the pan receiver includes a cylindrical portion connected to the mass detection unit and a plurality of branch portions extending at equal intervals in a circumferential direction in a horizontal direction around a central axis of the cylindrical portion, the moisture meter further comprises a pan support having an annular portion having an outer shape along an inner periphery of the windshield wall, a handle extending outward from the annular portion, and a plurality of tabs extending from the annular portion toward a center, the pan support being used for attaching and detaching the sample pan to and from the pan receiver, the annular portion includes the same number of wide portions as the tabs, each having a reference width, and the same number of narrow portions as the tabs, inner peripheral side of each being cut out to have width narrower than that of the wide portions, each narrow portion is disposed to face corresponding branch portion in a state where the sample pan is placed, and each tab is formed continuously with corresponding wide portion.
6. In the aspect 5, it is preferable that the plurality of tabs includes the same number of tabs as the branch portions, and the pan support includes repeating unit each including one narrow portion, one wide portion and one tub in this order.
7. In the aspects 5 and 6, it is preferable that the handle is provided on at least one of the wide portions.
8. In the aspects 5 to 7, it is preferable that the tabs are provided between the wide portions and the narrow portions, and the annular portion has notches formed in proximal end portions of the tabs so that the annular portion has same width at wide portion side and narrow portion side of the tabs.

### Advantageous Effects

According to the above aspect, it is possible to provide a heat-drying moisture meter which reduces the influence of convection on a sample pan.

### BRIEF DESCRIPTION OF DRAWINGS

FIG. 1 is an external perspective view of a moisture meter according to a first embodiment with a cover portion opened.

FIG. 2 is an external perspective view of the moisture meter with the cover portion closed.

FIG. 3 is a schematic exploded perspective view illustrating the internal structure of the cover portion of the moisture meter.

FIG. 4 is an exploded perspective view illustrating the structure of a weighing unit of the moisture meter.

FIG. 5A is a graph illustrating comparisons between weighing value changes with/without surface treatment of windshields. FIG. 5B is a graph illustrating comparisons between the temperature changes with/without surface treatment of the windshields.

FIGS. 6A and 6B are diagrams illustrating effects of influence of convection due to surface treatment.

FIG. 7 is a diagram illustrating the results of a thermal fluid analysis during heating, using a windshield with surface treatment according to an example.

FIG. 8 is a diagram illustrating the results of a thermal fluid analysis during heating using a windshield with surface treatment according to a comparative example.

FIGS. 9A and 9B are plan views of a weighing unit of a moisture meter according to a second embodiment.

FIG. 10 is a graph illustrating comparisons between weight value changes during heating, depending on the difference in size of the gaps between windshields and sample pans.

FIG. 11 is a diagram illustrating the results of a thermal fluid analysis during heating of the moisture meter according to an example of the second embodiment.

FIG. 12 is a diagram illustrating the results of a thermal fluid analysis during heating of the moisture meter according to another example of the second embodiment.

FIG. 13 is a diagram illustrating the results of a thermal fluid analysis during heating of the moisture meter according to the comparative example.

### DESCRIPTION OF EMBODIMENTS

Hereinafter, preferred embodiments of the present disclosure will be described with reference to the drawings. However, the present disclosure is not limited thereto.

### First Embodiment

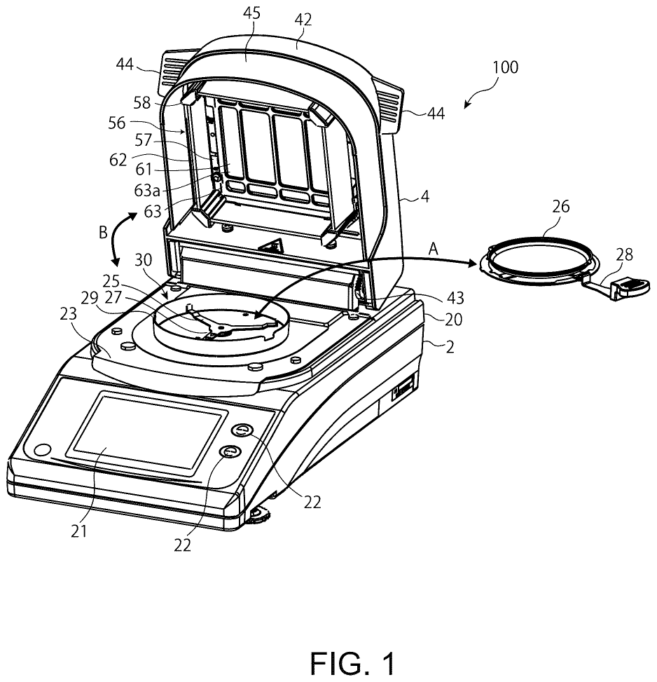

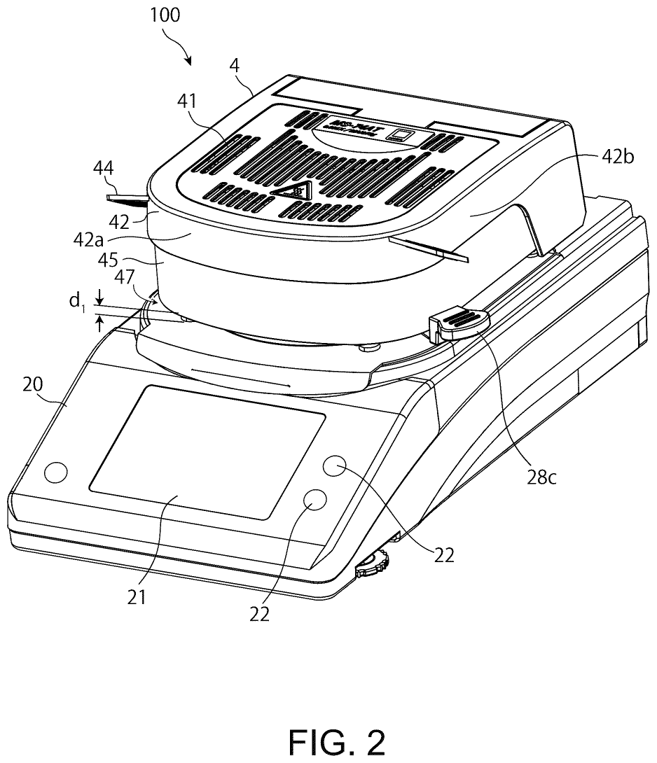

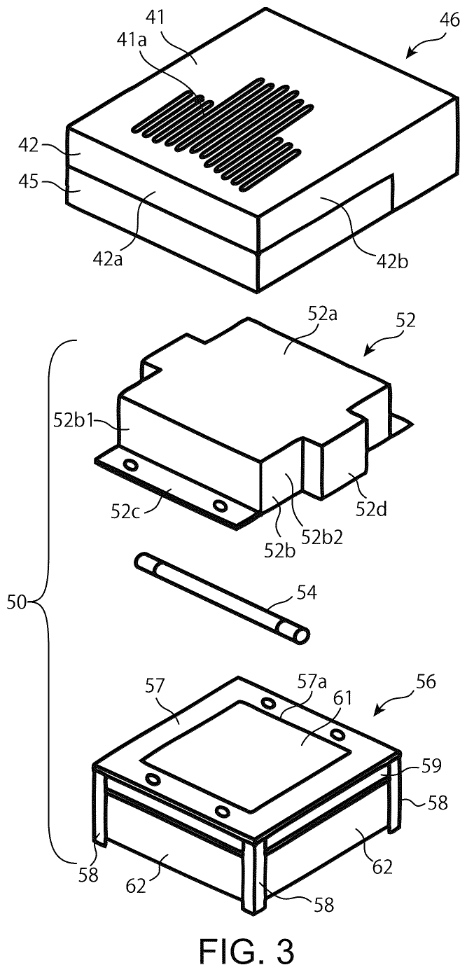

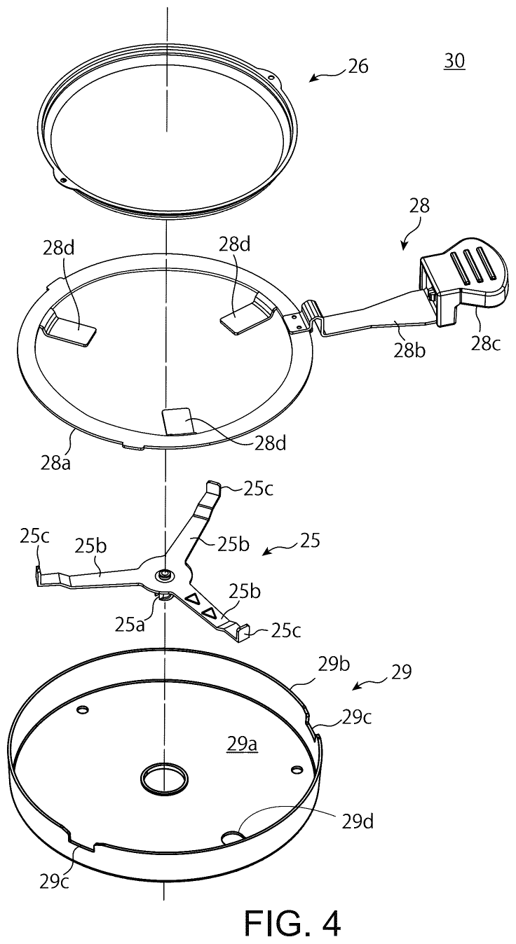

FIGS. 1 and 2 are perspective views of a moisture meter 100 according to a first embodiment. FIG. 1 illustrates an open state of a cover portion 4, and FIG. 2 illustrates a closed state of the cover portion 4. FIG. 3 is an exploded perspective view illustrating the internal structure of the cover portion 4. FIG. 4 is an exploded perspective view of a weighing unit 30 of the moisture meter 100. The moisture meter 100 includes a moisture meter body 2 and the cover portion 4.

The moisture meter body 2 includes a housing 20 having a substantially rectangular parallelepiped shape. The housing 20 has a display operation unit 21, which is configured as a touch panel display and operation buttons 22 on a front portion thereof. The moisture meter body 2 has an opening (not illustrated) substantially at the center of an upper surface 23. The housing 20 accommodates a mass detection unit (not illustrated). The mass detection unit has a mass sensor and a connecting shaft 27, and the connecting shaft is connected to the mass sensor via the opening. The mass detection unit may be implemented using a mass sensor such as an electromagnetic balance type, a strain gauge type (load cell type), or a capacitance type electronic sensor. The connecting shaft 27 supports a pan receiver 25 at the upper end thereof.

The pan receiver 25 includes a cylindrical portion 25a (FIG. 4), which is connected to the distal end of the connecting shaft 27, and three branch portions 25b, which extend at equal intervals in the circumferential direction in the horizontal direction from the upper end of the cylindrical portion 25a about the central axis of the cylindrical portion 25a. As indicated by an arrow A, a sample pan 26 is detachably placed on the pan receiver 25 by using a pan support 28 described later. The sample pan 26 has a circular shape with a flat central portion and a slightly rising peripheral edge portion. The sample pan 26 is surrounded by a windshield 29 having a bottomed short cylindrical shape. The pan receiver 25, the sample pan 26, the pan support 28, and the windshield 29 constitute the weighing unit 30 of the moisture meter 100.

Although not illustrated, the housing 20 houses various units such as an arithmetic processing unit, which processes detection results by the mass detection unit, a heat source drive unit, which drives a heat source to be described later, and a display drive unit, which drives the display operation unit 21 based on a processing result. Operating these respective units in response to the operations via the display operation unit 21 and the operation buttons 22 enables the moisture meter 100 to measure mass and moisture content of the sample placed on the sample pan to display the weighing value and moisture content on the display operation unit 21.

The cover portion 4 has a top surface 41 and a peripheral surface 42 and has a container shape opening toward the moisture meter body 2. The cover portion 4 is formed in a rectangular parallelepiped shape as a whole, but both corners of the front end are rounded. The cover portion 4 is pivotally supported by the moisture meter body 2 via a rotary shaft 43, which is provided on the back side of the moisture meter body 2. The cover portion 4 is thus swingable between an open position and a closed position about the rotary shaft 43 as indicated by an arrow B. In the closed state illustrated in FIG. 2, the cover portion 4 covers the entire weighing unit 30, thereby defining a heating chamber.

The cover portion 4 includes a heating unit 50 inside. The top surface 41 is provided with an exhaust port 41a. In the closed state, the cover portion 4 has a gap 47 of a predetermined distance d₁ between the upper surface 23 of the moisture meter body 2 and the lower end surface of the cover portion 4. The gap 47 and the exhaust port 41a create an air flow path, which enables various volatile components generated by heating the sample with the heating unit 50 to quickly exit to the outside.

The cover portion 4 has a window 45 at lower portions of a front surface 42a and a side surface 42b of the peripheral surface 42. The window 45 is formed of a plate material such as tempered glass plate or heat-resistant translucent resin plate, and allows a user to observe the state of the sample placed on the sample pan in the closed state. The cover portion 4 is provided with a pair of handles 44 protruding outward from both sides of the front end of the peripheral surface 42 to facilitate opening and closing.

Here, details of the cover portion 4 will be described with reference to FIGS. 1 and 3. As described above, the cover portion 4 has a rectangular parallelepiped shape with the rounded front end. However, for convenience of drawing, the cover portion 4 is illustrated as a rectangular parallelepiped shape in FIG. 3. For convenience of description, directions such as upward and downward directions will be described based on the closed state unless otherwise specified. In FIG. 3, the downward direction is a direction toward the weighing unit 30. The cover portion 4 is configured to cover the heating unit 50 with a heater cover 46 constituting the top surface 41 and the peripheral surface 42.

The heating unit 50 includes, from the top surface 41 side, a reflector 52, which is accommodated inside the heater cover 46, a tubular halogen lamp 54, which is a heating light source i.e., a heater, and is attached to the reflector 52, and a sample pan cover 56. The heating light source is not limited to the halogen lamp 54 and may be an infrared lamp, a ceramic heater, or the like.

The reflector 52 includes a substantially rectangular top plate 52a, which faces the weighing unit 30, and a peripheral wall 52b, which extends from a peripheral edge of the top plate 52a toward the weighing unit 30. The reflector 52 is formed in a container shape having a rectangular opening toward the weighing unit 30. The peripheral wall 52b has flanges 52c extending in the front-rear direction form lower end of the front and rear peripheral walls 52b1. The peripheral wall 52b has left and right peripheral walls 52b2 having protrusions 52d protruding outward near the center in the front-rear direction. The halogen lamp 54 is attached inside the protrusions 52d. The reflector 52 has a reflecting surface which is formed on the inner surface of the reflector 52 by various methods such as metal vapor deposition or attachment of aluminum foil. This surface efficiently reflects light from the halogen lamp 54 to enable uniform irradiation of the sample.

The sample pan cover 56 generally has a container shape that opens in a rectangular shape toward the weighing unit 30. The sample pan cover 56 has a substantially rectangular frame 57 which faces to the weighing unit 30 and poles 58 which are disposed at four corners of the frame 57 and extending downward. The frame 57 has a rectangular opening 57a at the center, and the opening 57a is closed by a transparent plate 61.

The frame 57 is made of metal such as an aluminum plate. The transparent plate 61 is made of transparent material, such as tempered glass or heat-resistant translucent resin. The transparent plate 61 is equipped with a protective plate 63 which is attached to its surface that faces the weighing unit 30. The protective plate 63 prevents damage to the transparent plate 61 caused by collision of a sample or other materials. The protective plate 63 is formed of narrow bars 63a that cross in front of the halogen lamp 54 and extend across the opening of the frame 57.

The poles 58 are configured to abut on the upper surface 23 of the moisture meter body 2 when the cover portion 4 is tilted toward the moisture meter body 2 to close the cover portion 4. Thus, the poles 58 function as stoppers.

Further, transparent plates 62 made of rectangular tempered glass or heat-resistant resin are disposed between the adjacent poles 58 to constitute peripheral walls of the sample pan cover 56. This allows a user to observe a sample through the window 45 of the heater cover 46.

The length of the transparent plate 62 in the height direction is set to be shorter than the height of each pole 58, so as to form a gap vertically in the closed state of the cover portion 4. Further, each transparent plate 62 is placed away from the frame 57 by a predetermined distance. This configuration creates an airflow path inside the sample pan cover 56 in the moisture meter 100. The air flow enters through from the gap on the lower side of the heater cover 46, passes through the gap on the lower side of the transparent plate 62 and the gap on the upper side of the transparent plate 62, and exits from the exhaust port 41a of the heater cover 46. This allows prompt discharge of various components evaporated from the sample. The halogen lamp 54, the reflector 52, the sample pan cover 56, the opening 57a, and the sample pan 26 are arranged such that the central axes coincide with each other. This allows efficient heating of the sample.

Next, the configuration of the weighing unit 30 will be described in detail. As illustrated in FIG. 4, the pan support 28 includes an annular portion 28a and a handle 28b extending outward in the horizontal direction from the annular portion 28a by a predetermined distance. The annular portion 28a has a ring-shaped configuration. The annular portion 28a is larger than the pan receiver 25 and the sample pan 26 in plan view and is slightly smaller than the inner diameter of the windshield 29.

The free end of the handle 28b is bent upward, and equipped with a handle cover 28c. In the closed state illustrated in FIG. 2, the handle cover 28c is positioned outside the space defined by the cover portion 4. This prevents the handle cover 28c from being heated during heating.

The annular portion 28a has three tabs 28d which are formed in a rectangular shape in plan view, and which extend by a predetermined distance in the horizontal direction toward the center thereof. For example, the three tabs 28d are provided at equal intervals in the circumferential direction. Each tab 28d is bent downward by a length corresponding to the rising part of the outer edge portion of the sample pan 26 at the proximal end portion and then horizontally extends inward. When placing or removing the sample pan 26 on or from the pan receiver 25, lifting the handle 28b causes the tabs 28d to support the bottom surface of the sample pan 26 while the annular portion 28a engages with the edge portion of the sample pan 26, thereby lifting the sample pan 26 stably.

The windshield 29 has a bottomed short cylindrical shape having a bottom surface 29a and a peripheral wall (hereinafter referred to as a windshield wall) 29b extending upward substantially orthogonal to the bottom surface 29a. The windshield wall 29b extends above the upper end of the sample pan 26 in a state where the sample pan 26 is placed on the pan receiver 25. The windshield wall 29b has two notches 29c formed at its upper end. The notches 29c are used for positioning the pan support 28. It should be noted that the windshield 29 does not necessarily have to be provided with the bottom surface 29a and may have just a short cylindrical shape formed only of the windshield wall 29b, for example.

Two triangular marks are provided on one of the three branch portions 25b of the pan receiver 25. Aligning the marks with a positioning hole 29d provided in the bottom surface 29a of the windshield 29 positions the cylindrical portion 25a in the circumferential direction to the connecting shaft 27. This allows correct mounting of the pan receiver 25 to the moisture meter body 2.

The pan receiver 25, the pan support 28, and the windshield 29 constituting the weighing unit 30 are made of stainless steel. The sample pan 26 is made of, but not limited to, aluminum. The windshield 29 has undergone a treatment for decreasing the thermal reflectance of the surface. Examples of the treatment method include barrel polishing, sandblasting, and black chromium plating. The thermal reflectance of the surface is lowered to 50% or less by barrel polishing, 40% or less by sandblasting, and 3% or less by black chromium plating. The range of the thermal reflectance is preferably 50% or less, more preferably 40% or less, and particularly advantageously 3% or less.

### Experiment

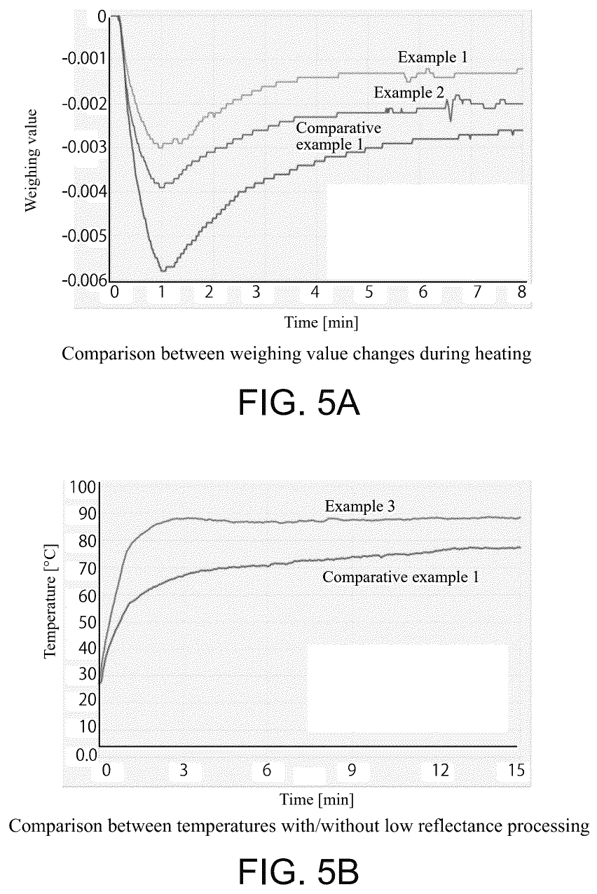

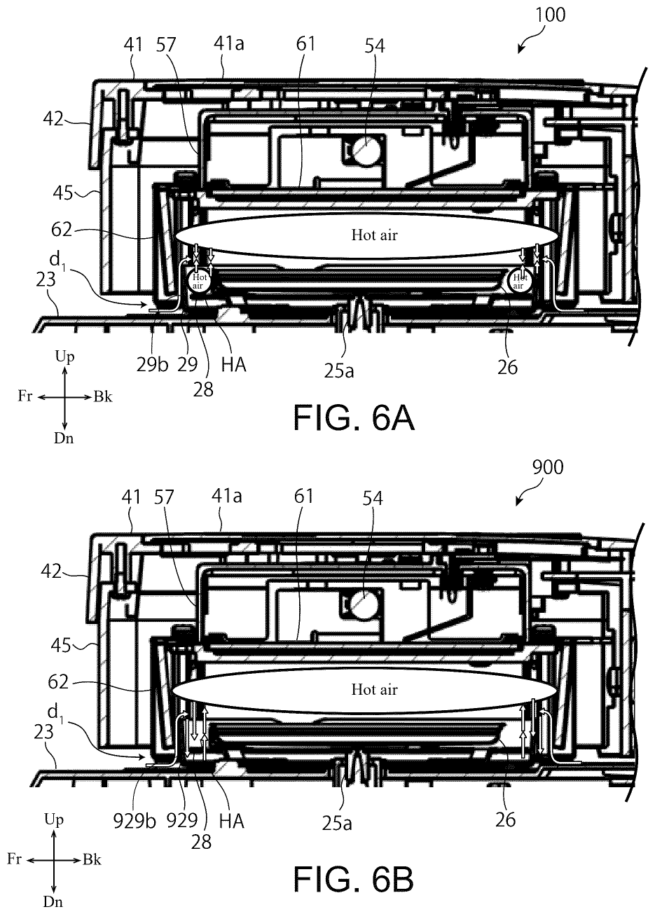

FIG. 5A illustrates the differences between weighing value changes with/without surface treatment of windshields. As Example 1, the moisture meter 100 uses the windshield 29 whose surface is plated with black chromium (thermal reflectance: 3%). As Example 2, the moisture meter 100 uses the windshield 29 whose surface is processed with barrel polishing (thermal reflectance: 50%). As Comparative Example 1, a windshield 929 made of stainless steel having a glossy surface (thermal reflectance: 70%) is used in a moisture meter 900 (see FIG. 6B) having the same mechanical configuration as the moisture meter 100 except for the windshield 29. Comparison was made among Examples 1 and 2 and Comparative Example 1 on weighing value changes of samples when the samples were not placed on the moisture and heated at 160° C. for 8 minutes. As can be seen from FIG. 5A, in Comparative Example 1, the weighing value changed to largely negative in 1 minute from the start of heating, whereas in Examples 1 and 2, the weighing value change occurring in 1 minute from the start of heating was small. This shows that the weighing value change in the negative direction was reduced by the surface treatment on the windshield 29 to lower the thermal reflectance.

Next, to closely examine the cause of the decrease in the weighing value change, the differences in surface temperature of windshields with/without surface treatment for lowering the thermal reflectance were compared. FIG. 5B is a graph obtained by measuring temporal changes in the temperatures of the windshields with/without surface treatment. Here, as Example 3, the moisture meter 100 according to the above-described embodiment using the windshield 29 whose surface is sandblasted (thermal reflectance: 40%). On the other hand, Comparative Example 1 was the same one as that according to FIG. 5A. As can be seen from FIG. 5B, with the surface treatment for lowering the thermal reflectance, the temperature rises fast, and the steady-state temperature is higher than that of the case without the surface treatment. This is presumed to be a factor that causes differences in the influence of convection with/without surface treatment.

The effect of reducing the influence of convection with surface treatment based on the above presumption will be described with reference to FIGS. 6A and 6B. FIG. 6A is a longitudinal cross-sectional view of the vicinity of the weighing unit 30 and the cover portion 4 of the moisture meter 100 according to Example 1 along the front-rear direction. The same applies to Examples 2 and 3. FIG. 6B is a longitudinal sectional view corresponding to FIG. 6A of the moisture meter 900 according to Comparative Example 1.

In Comparative Example 1, the temperature of windshield 929 is relatively low. Therefore, when heating is started by the moisture meter 900, as illustrated in FIG. 6B, the high-temperature air heated by the halogen lamp 54 stagnates in the upper portion of the sample pan 26. The air flowing from the lower end of the transparent plate 62 rises from the gap between the windshield 29 and the transparent plate 62 along a windshield wall 929b, and flows into the gap between the windshield wall 929b and the sample pan 26 at the upper end thereof. The high-temperature air in the upper portion of the sample pan also expands and flows into the gap between windshield wall 929b and sample pan 26. As a result, convection is generated in the gap between sample pan 26 and windshield wall 929b, in particular, rising up from bottom to top along the outer edge of the sample pan 26.

This makes the weighing value smaller than the actual value. On the other hand, in Example 1, as illustrated in FIG. 6A, in addition to the high-temperature air stagnating in the upper portion of the sample pan 26, the air in the gap between the windshield wall 29b and the outer edge of the sample pan 26 is also warmed by the temperature rise of the windshield 29 to become high temperature air. Therefore, the air flowing in from the outside and the high-temperature air on the upper portion of the sample pan are bounced back by the high-temperature air between the windshield wall 29b and the sample pan 26. That is, the air hardly flows into the gap between the sample pan 26 and the windshield wall 29b. For this reason, convection that rises from the bottom to the top along the outer edge of the sample pan 26 is less likely to occur, and fluctuations in the weighing value are suppressed.

### Thermal Fluid Analysis

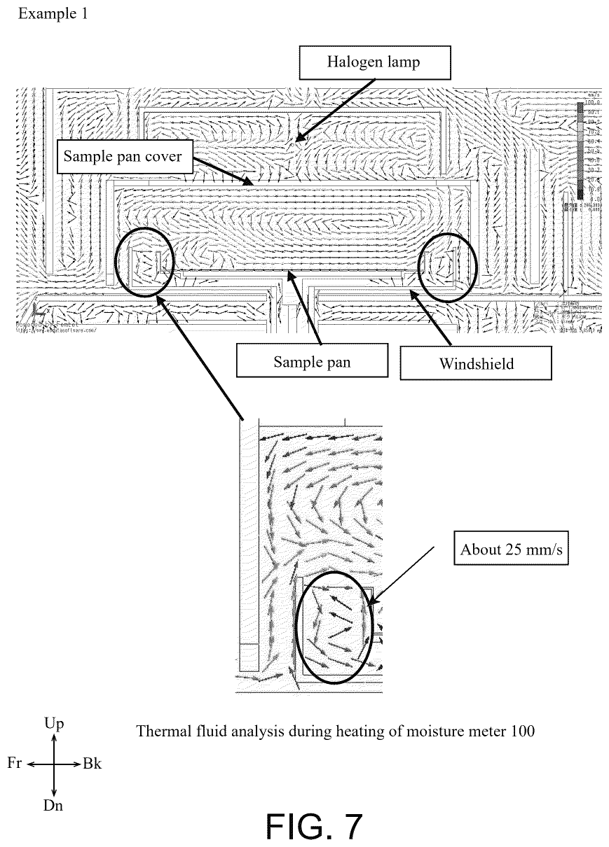

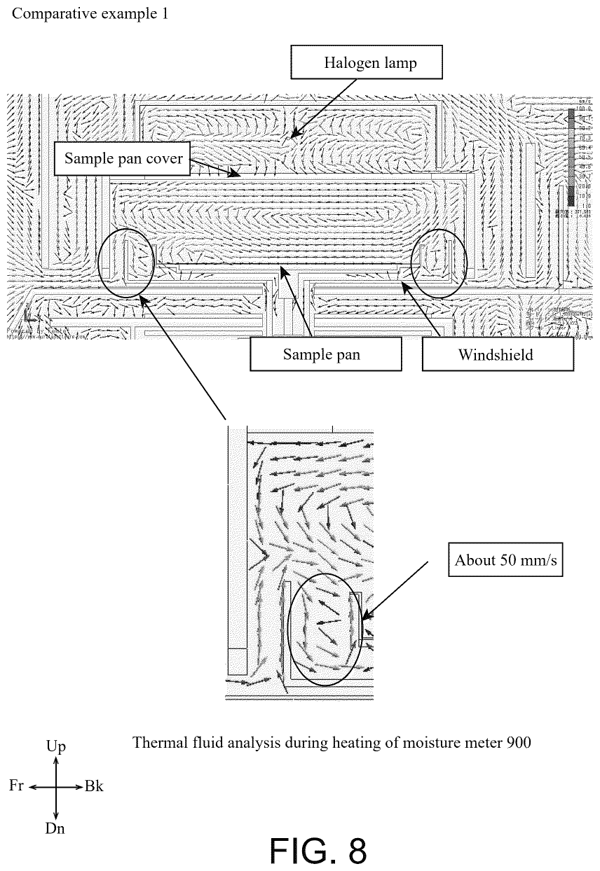

This is also evidenced by thermal fluid analysis. FIG. 7 illustrates the results of thermal fluid analysis during transition from the start of heating toward the steady state when the moisture meter 100 according to Example 1 is heated at a set heating temperature of 200° C. FIG. 8 illustrates the results of thermal fluid analysis during transition from the start of heating toward the steady state when the moisture meter 900 according to Comparative Example 1 is heated at a set heating temperature of 200° C. The thermal fluid analyses were conducted using Murata Software's Femtet, assuming that the halogen lamp 54 generated heat at 1,400° C.

As seen from FIGS. 7 and 8, the upward convection in the gap between the windshield wall 929b and the sample pan 26 on the outer edge portion side of the sample pan 26 was about 50 mm/s in Comparative Example 1, whereas the upward convection in the gap between the windshield 292 and the sample pan 26 on the outer edge portion side of the sample pan 26 was greatly reduced to about 25 mm/s in Example 1. Thus, Example 1 reduced the weighing value change caused by such convection.

As described above, according to the present embodiment, making the surface of components of the weighing unit 30, particularly, the windshield 29, have a low reflectance reduces the influence of convection, thereby improving the accuracy of moisture content measurement.

It is also advantageous to lower the thermal reflectance of the surfaces of the pan receiver 25, the sample pan 26, and the pan support 28 in addition to the windshield 29. This is because such configuration results in a faster temperature rise rate throughout the entire weighing unit after the start of heating and also achieves a higher steady-state temperature. This makes it possible to maintain the vicinity of windshield wall 29b at a high temperature, thereby improving the convection suppression effect. It should be noted that the moisture meter 100 of the present embodiment does not necessarily have to include the pan support 28. Other tool such as tweezers may be used for placing and removing the sample pan 26 onto and from the pan receiver 25.

### Second Embodiment

In the course of the investigation, the inventors have found that it is preferable to minimize the gap between the sample pan 26 and the windshield wall 29b to reduce the influence of the upward convection generated in the gap between the sample pan 26 and the windshield wall 29b. Therefore, a moisture meter 200 according to a second embodiment, is configured such that the pan support 28 is modified to have a structure suitable for minimizing the gap between the sample pan 26 and the windshield wall 29b in the moisture meter 100.

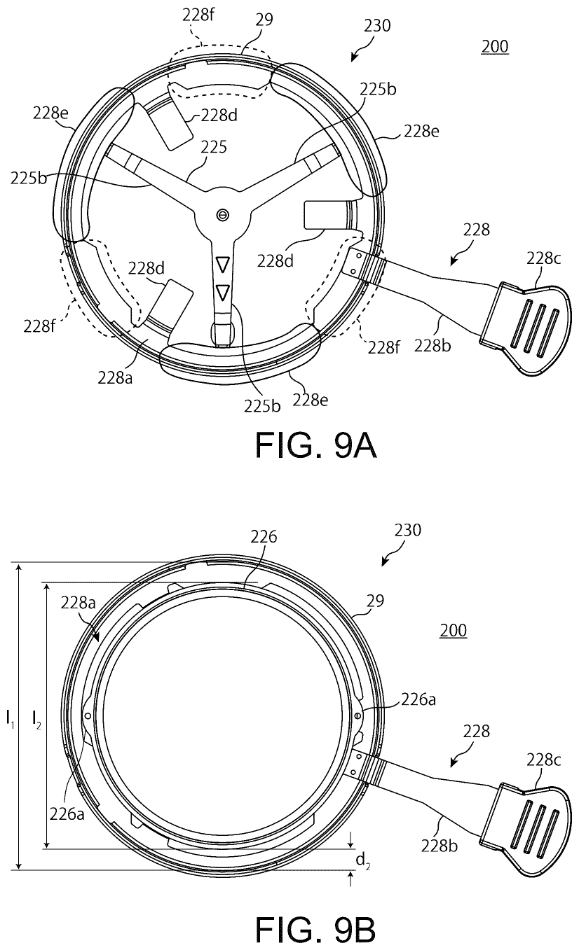

FIGS. 9A and 9B are plan views of a weighing unit 230 of the moisture meter 200 according to the second embodiment. FIG. 9A illustrates the weighing unit 230 with a sample pan 226 removed, and FIG. 9B illustrates the weighing unit 230 with the sample pan 226 placed. The weighing unit 230 schematically has the same configuration as the weighing unit 30 of the moisture meter 100, except for the dimensions of the sample pan 226 and the shape of a pan support 228. Specifically, the weighing unit 230 includes a windshield 29, a pan receiver 225, the pan support 228, and the sample pan 226. The sample pan 226 has the same shape as the sample pan 26 but is different from the sample pan 26 in that the dimensions of the sample pan 226 are set such that a distance d₂ between the inner wall of the windshield wall 29b and the outer edge portion of the sample pan 226, that is, the gap between the outer edge of the sample pan 226 and the windshield wall 29b, is 9 mm or less. The gap is preferably set to be as small as possible. However, as described below, setting the gap is 9 mm or less reduces the speed of convection, thereby reducing the influence on the weighing value. It should be noted that a diameter l₂ of the sample pan 226 is set according to models and purposes of the moisture meter. In the illustrated example, the diameter l₂ of the sample pan 226 is 95 mm, and the diameter l₁ of the inner periphery of the windshield wall 29b is 112 mm.

It should be noted that, as illustrated in FIG. 9B, the sample pan 226 may have a bulging portion 226a that bulges outward, instead of a perfect circle. Also in this case, the diameter l₂ of the sample pan 226 refers to the diameter of a circle not including the bulging portion 226a. Similarly to the sample pan 26, the peripheral edge portion of the sample pan 226 slightly rises while slightly expanding in diameter outward. For this reason, the diameter of the sample pan 226 slightly differs between the bottom surface and the outer edge portion. In this specification, unless otherwise specified, the diameter l₂ of the sample pan 226 means the diameter of the outer edge portion of the sample pan 226. The sample pan 226 has a nominal size for convenience, and the sample pan 226 having the diameter l₂ of 95 mm corresponds to the nominal size of “diameter of 90 mm”.

The pan receiver 225 has branch potions 225b whose radial dimension corresponding to the dimension of the sample pan 226. Similarly to the pan support 28, the pan support 228 includes an annular portion 228a and a handle 228b extending outward in the horizontal direction from the annular portion 228a by a predetermined distance. The annular portion 228a is provided with three tabs 228d each having a rectangular shape in plan view and extending in the horizontal direction toward the center of the annular portion 228a by a predetermined distance.

The annular portion 228a has a ring-shaped configuration, but the length between the outer periphery and the inner periphery (i.e., annular width) is not constant. Specifically, the annular portion 228a includes wide portions 228f having reference widths of the annular portion 228a and narrow portions 228e whose widths are narrowed by cutting out the inner periphery along the circumferential direction. The narrow portions 228e are formed at three positions at equal intervals in the circumferential direction with the same dimensions so that each faces to the corresponding branch portion 225b of the pan receiver 225 when the pan support 228 is disposed in the windshield 29. This allows the pan support 228 not to interfere with the tip of the branch portion 225b.

Each of the narrow portions 228e extends from the proximal end portion of the tab 228d to the middle between the adjacent tabs 228d in the circumferential direction. As a result, the wide portion 228f is disposed on one side (the left side in the illustrated example) of each tab 228d in the circumferential direction, and the narrow portion 228e is disposed on the other side (the right side in the illustrated example). That is, the pan support 228 is configured such that the narrow portions 228e face the branch portions 225b of the pan receiver 225, and the tabs 228d to which loads are applied are formed continuously with the wide portion 228f. However, the annular portion 228a has notches at the wide portion 228f side of the proximal end portions of the tabs 228d so that the annular portion 228a has the same annular width at the wide portion 228f side and the narrow portion 228e side. The handle 28b is provided on the wide portion 228f.

### Effect of Structure of Pan Support

The above configuration allows the pan support 228, even if its outer diameter is the same as that of the pan support 28 supporting the sample pan 26, can support the sample pan 226 that is larger than the sample pan 26 while securing strength. As the pan support 228 can support the larger sample pan 226 even with the same outer diameter as the pan support 28, the annular width of the pan support can be reduced, thereby reducing the gap between the windshield wall 29b and the outer edge of the sample pan 226. Providing the tabs 228d to which load is applied to be adjacent to the wide portion 228f secures necessary strength. Providing the annular portion 228a with notches at the wide portion 228f side of the proximal end of the tabs 228d so that the annular portion 228a has the same annular width at the wide portion 228f side and the narrow portion 228e side of the tabs 228d, prevents stress from becoming localized between left and right of the proximal ends of the tabs 228. This contributes to improvement in strength.

### Effect by Size of Gap

### EXPERIMENT

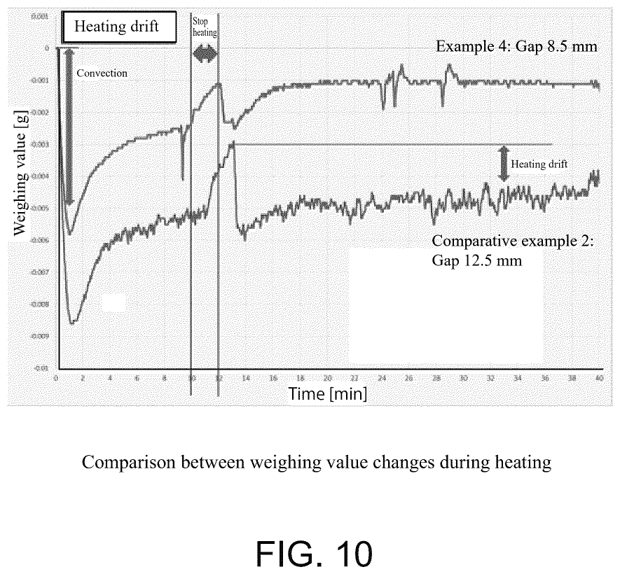

FIG. 10 is a graph illustrating differences in weighing value changes when the size of the gap between the sample pan and the windshield inner periphery changes. As Example 4, a moisture meter having the configuration as the moisture meter 200 is used, wherein a sample pan 226 has a diameter l₂ of 95 mm (nominal size: diameter of 90 mm) without surface treatment and a windshield 29 has an inner diameter of 112 mm. The gap in Example 4 was 8.5 mm in actual measurement value. As Comparative Example 2, a moisture meter 950 having the mechanical configuration same as the moisture meter 200, except that a sample pan 926 has a diameter l₂ of 87 mm (nominal size: diameter of 85 mm). A windshield 29 in Comparative Example 2 had an inner diameter of 112 mm, which is equal to that of Example 4. The gap in Comparative Example 2 was 12.5 mm in actual measurement value. In the experiment, each of the moisture meters 200 and 950 was heated with no sample. First, heating was performed at 160° C. for 10 minutes and stopped for 2 minutes, consequently, further performed for 38 minutes, to measure a change in weighing value. The reason why the heating was temporarily stopped for 2 minutes in the middle of the process was to confirm the influence of the heating drift.

As can be seen from FIG. 10, Example 4 in which the gap was narrower, clearly reduced the weighing value change in the negative direction due to the influence of convection. In terms of heating drift after stopping heating, Example 4 reduced the heating drift to 0.01 mg as compared with Comparative Example 2 in which the heating drift was 1.7 mg. As a result of conducting similar experiments a plurality of times, the inventors have found that the influence of convection is clearly reduced when at least the size of the gap is designed to be smaller than 9 mm.

FIGS. 9A and 9 illustrates the pan support 225 having the three branch portions 225a. However, the number of branch portions 225a is not limited to three; it may be two or four or more, as long as it can stably support the sample pan 226. Furthermore, it is preferable that the number of tabs 228d, narrow portions 228e, and wide portions 228f is the same, and that the number of tabs 228d is the same as the branch portions 225a. This enables the annular portion 228a to include repeating units each including one narrow portion 228e, one wide portion 228f and one tub 228d in the same order as shown in FIG. 9A, resulting in stress homogenization and improved strength. However, this is also not essential; for example, the number of tabs 228a may be an integer multiple of the number of branch portions 225a.

### Thermal Fluid Analysis

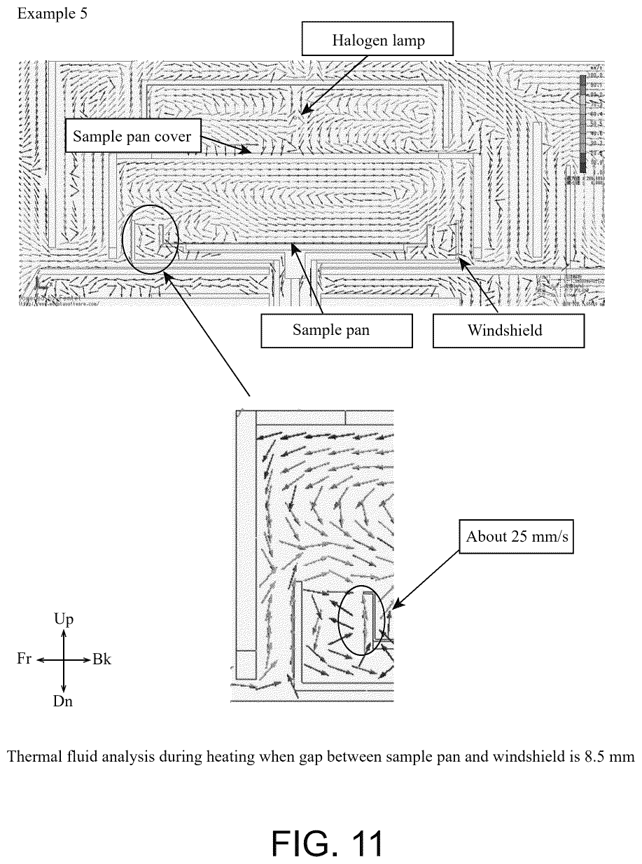

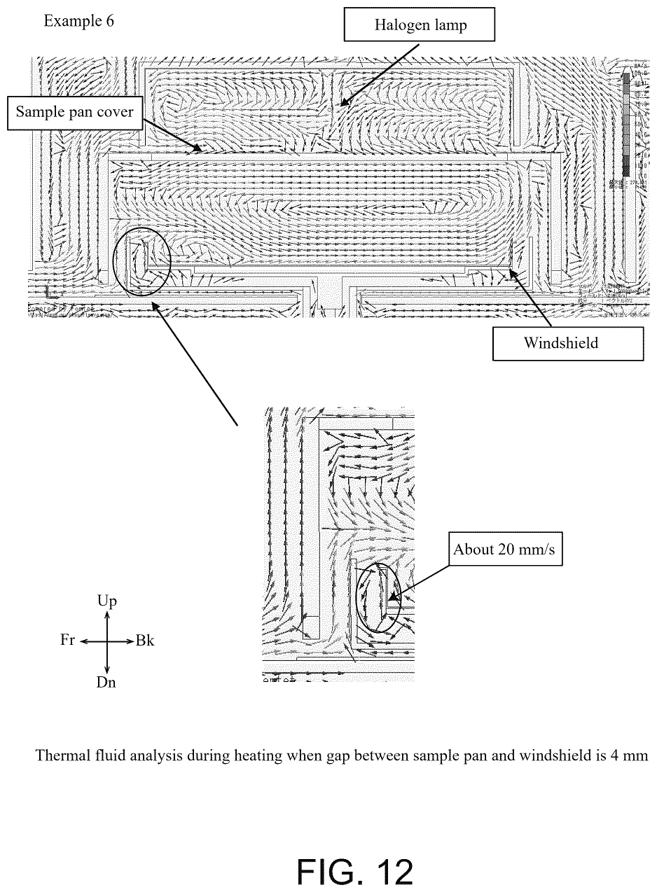

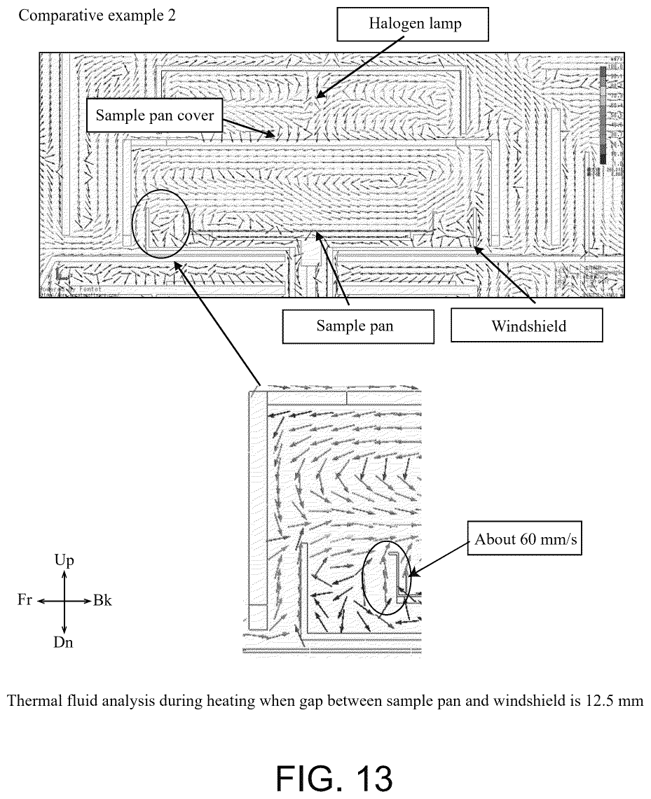

FIGS. 11, 12, and 13 illustrate the results of thermal fluid analysis during transition from the start of heating toward the steady state when moisture meters including the sample pans 226 having different sizes were heated at a set heating temperature of 200° C. using the windshield 29 having the same size as that of Example 4, that is, the inner diameter of 112 mm. FIG. 11 illustrates the results for Example 5 using the sample pan 226 having a diameter l₂ of 95 mm (nominal size: diameter of 90 mm). FIG. 12 illustrates the results for Example 6 using a sample pan 226 having a diameter l₂ of 104 mm (nominal size: diameter of 100 mm). FIG. 13 illustrates the results for Comparative Example 2 as in the above experiment, using the sample pan 26 having the diameter l₂ of 87 mm (nominal size: diameter of 85 mm). The gaps between the sample pans and the windshield walls are 8.5 mm, 4 mm and 12.5 mm, respectively in Example 5, Example 6, and Comparative Example 2. The thermal fluid analyses were conducted using Murata Software's Femtet, assuming that the halogen lamp 54 generated heat at 1,400° C.

FIG. 13 illustrates that the speed of upward convection flowing along the outer edge of the sample pan was 60 mm/s, whereas FIG. 11 illustrates that the speed was 25 mm/s. This shows that Example 5 clearly reduced the influence of convection. Further, FIG. 12 illustrates that the speed was 20 mm/s. This shows that the speed was further reduced. As described above, it can be seen that the influence of convection was reduced progressively as the gap between the inner periphery of the windshield wall 29b and the outer edge portion of the sample pan 226 is narrowed. As a result of repeating similar thermal fluid analysis, it has been found that setting the gap between the inner periphery of the windshield wall 29b and the outer edge portion of the sample pan 226 to 9 mm or less reduces the influence of convection.

It should be noted that, similarly to the moisture meter 100, the moisture meter 200 does not necessarily have to be provided with the pan support 228, and the influence of convection can be reduced by narrowing the gap between the sample pan 226 and the windshield wall 29b as described above. However, providing the pan support 228 having the above configuration is advantageous because the influence of convection can be reduced without impairing convenience during measurement.

It should be noted that, the effect of reducing the influence of convection by reducing the gap between the inner periphery of the windshield wall 29b and the outer edge portion of the sample pan 226 can be achieved without reducing the reflectance by the surface treatment on the windshield 29. However, the effect of reducing the influence of convection can be further enhanced by simultaneously reducing the reflectance of the windshield 29 and reducing the gap.

Although the preferred embodiments of the present disclosure have been described above, the embodiments are just examples of the present disclosure, and these can be combined based on knowledge of a person skilled in the art, and such a combined embodiment is also included in the scope of the present disclosure.

### REFERENCE SIGNS LIST

2: Moisture meter body
4: Cover portion
20: Housing
23: Upper surface
25: Pan receiver
25a: Cylindrical portion
25b: Branch portion
26: Sample pan
28: Pan support
28a: Annular portion
28b: Handle
28d: Tab
29: Windshield
29b: Windshield wall
29c: Notch
41: Top surface
52d: Protrusion
100: Moisture meter
200: Moisture meter
225: Pan receiver
225b: Branch portion
226: Sample pan
228: Pan support
228a: Annular portion
228b: Handle
228d: Tab
228e: Narrow portion
228f: Wide portion

1. A moisture meter comprising:
a moisture meter body including a housing and a mass detection unit accommodated therein that detects a load;
a pan receiver attached to the mass detection unit on an upper surface of the housing;
a sample pan detachably placed on the pan receiver;
a cylindrical windshield wall provided around the sample pan; and
a cover portion that is openably/closably provided on the housing, accommodates a heater therein, covers the sample pan in a closed state, to define a heating chamber,
wherein the windshield wall has a surface thermal reflectance of 50% or less.

2. The moisture meter according to claim 1, wherein speed of convection caused by air flowing between an outer edge of the sample pan and the windshield wall and flowing upward along the outer edge of the sample pan is reduced by setting the surface thermal reflectance to 50% or less.

3. The moisture meter according to claim 1, wherein a distance between an outer edge of the sample pan and the windshield wall is set in consideration of speed of convection caused by air flowing between the outer edge of the sample pan and the windshield wall and flowing upward along the outer edge of the sample pan.

4. The moisture meter according to claim 1, wherein a distance between an outer edge of the sample pan and the windshield wall is 9 mm or less.

5. The moisture meter according to claim 1, wherein the pan receiver includes a cylindrical portion connected to the mass detection unit and a plurality of branch portions extending at equal intervals in a circumferential direction in a horizontal direction around a central axis of the cylindrical portion,
the moisture meter further comprises a pan support having an annular portion having an outer shape along an inner periphery of the windshield wall, a handle extending outward from the annular portion, and a plurality of tabs extending from the annular portion toward a center, the pan support being used for attaching and detaching the sample pan to and from the pan receiver,
the annular portion includes the same number of wide portions as the tabs, each having a reference width, and the same number of narrow portions as the tabs, inner peripheral side of each being cut out to have width narrower than that of the wide portions,
each narrow portion is disposed to face corresponding branch portion in a state where the sample pan is placed, and
each tab is formed continuously with corresponding wide portion.

6. The moisture meter according to claim 5,
wherein the plurality of tabs includes the same number of tabs as the branch portions, and
wherein the pan support includes repeating unit each including one narrow portion, one wide portion and one tub in this order.

7. The moisture meter according to claim 5,
wherein the handle is provided on at least one of the wide portions.

8. The moisture meter according to claim 6,
wherein the handle is provided on at least one of the wide portions.

9. The moisture meter according to claim 5, wherein the tabs are provided between the wide portions and the narrow portions, and
the annular portion has notches formed in proximal end portions of the tabs so that the annular portion has same width at wide portion side and narrow portion side of the tabs.

10. The moisture meter according to claim 6, wherein the tab is provided between the wide portion and the narrow portion, and
the annular portion has a notch formed in proximal end portions of the tab so that the annular portion has same widths at wide portion side and narrow portion side of the tabs.

11. A moisture meter comprising:
a moisture meter body including a housing and a mass detection unit accommodated therein that detects a load;
a pan receiver attached to the mass detection unit on an upper surface of the housing;
a sample pan detachably placed on the pan receiver;
a cylindrical windshield wall provided around the sample pan; and
a cover portion that is openably/closably provided on the housing, accommodates a heater therein, covers the sample pan in a closed state, to define a heating chamber,
wherein a distance between an outer edge of the sample pan and the windshield wall is 9 mm or less.

12. The moisture meter according to claim 11, wherein the pan receiver includes a cylindrical portion connected to the mass detection unit and a plurality of branch portions extending at equal intervals in a circumferential direction in a horizontal direction around a central axis of the cylindrical portion,
the moisture meter further comprises a pan support having an annular portion having an outer shape along an inner periphery of the windshield wall, a handle extending outward from the annular portion, and a plurality of tabs extending from the annular portion toward a center, the pan support being used for attaching and detaching the sample pan to and from the pan receiver,
the annular portion includes the same number of wide portions as the tabs, each having a reference width, and the same number of narrow portions as the tabs, each inner peripheral side notched to have a width narrower than that of the wide portions,
each narrow portion is disposed to face corresponding branch portion in a state where the sample pan is placed, and
each tab is formed continuously with corresponding wide portion.
